(19) United States
(12) Patent Application Publication
(10) Pub. No.: US 2017/0228441 A1
(43) Pub. Date: Aug. 10, 2017

(54) SYSTEM AND METHOD FOR PROVIDING ENTERTAINMENT INFORMATION

(71) Applicant: Christopher Aaron Curry, Dell Rapids, SD (US)

(72) Inventor: Christopher Aaron Curry, Dell Rapids, SD (US)

(21) Appl. No.: 15/423,875

(22) Filed: Feb. 3, 2017

Related U.S. Application Data
(60) Provisional application No. 62/291,456, filed on Feb. 4, 2016.
(60) Provisional application No. 62/291,371, filed on Feb. 4, 2016.

(51) Int. Cl. G06F 17/30

(52) U.S. Cl. CPC G06F 17/30554; G06F 17/30241; G06F 17/3087; G06F 17/30867; G06F 17/3053; G06F 3/0482

(57) ABSTRACT

A system and method comprises creating a database of activities each having an activity location, performing an initiation process for a new user to create a user record in the database, and initiating a user session. The initiation comprises determining a user location, presenting an initial screen on an information handling device with a map representation, and displaying on the map representation at least one mark representing the activity at the activity location. The method comprises receiving an activity selection from a user, displaying further information on the selected activity, providing a rating input for activities, and maintaining a count of ratings made by users for each activity. The method comprises changing a display characteristic of the mark for an activity based upon the count of positive ratings for the activity relative to the counts of positive ratings for other activities displayed on the map representation, or changing a display characteristic of the mark for an activity having the count of positive ratings above a threshold level.

### PRIOR RELATED APPLICATIONS

This application claims the benefit of U.S. Provisional Patent Application No. 62/291,456 entitled “PartySpot,” filed on Feb. 4, 2016, and U.S. Provisional Patent Application No. 62/291,371 entitled “PartySpot,” filed on Feb. 4, 2016.

### FEDERALLY SPONSORED RESEARCH STATEMENT

Not Applicable (“N/A”)

### REFERENCE TO MICROFICHE APPENDIX

N/A

### BACKGROUND AND FIELD OF INVENTION

The present disclosure relates to entertainment guide systems and more particularly pertains to a new system and method for providing entertainment information.

### SUMMARY OF THE INVENTION

The present disclosure relates to a method that may include creating a database of activities, with each activity having an activity location associated with the activity, and performing an initiation process for a new user to create a user record in the database. The method may further comprise initiating a user session, including determining a location for the user and presenting an initial screen on the user's information handling device, and may further include displaying a map representation on the initial screen of the information handling device and displaying on the map representation at least one mark representing the activity location of the corresponding activity. The method may further include receiving an activity selection from a user of the information handling device and displaying further information regarding the activity selected by the user. The method may also include providing a positive rating input for the selected activity, with the positive rating input being located on the window with the further information, maintaining a count of positive ratings made by users for each of the activities, and changing a display characteristic of the mark for a said activity based upon the count of the positive rating for the said activity relative to the counts of positive ratings for other said activities displayed on the map representation.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components, and the particulars of the steps, set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

In an embodiment, a system for providing entertainment information comprises: a) information from a user's information handing device, wherein the user's information handling device comprises a display screen; b) a processor connected to a communication network for receiving the information; c) a storage connected to the processor, wherein the storage is a non-transitory computer readable medium; d) computer instructions in the storage to create a database of activities, wherein each of the activities have an activity location associated with the activity; e) computer instructions in the storage to perform an initiation process for a user to create or modify a user record in the database; f) computer instructions in the storage to initiate a user session, including: i) computer instructions to determine a location for the user; ii) computer instructions to present an initial screen on the display screen of the user's information handling device, including: A) computer instructions to display a map representation on the initial screen of the user's information handling device; B) computer instructions to display on the map representation at least one mark representing the activity location of the corresponding activity; and C) computer instructions to request and to receive an activity selection from the user.

In an embodiment, the system further comprises computer instructions in the storage to display further information regarding the activity selected by the user.

In an embodiment, the system may further comprise computer instructions in the storage to provide a rating input for the selected activity, wherein the rating input being displayed on the screen with the further information.

In an embodiment, the system further comprises computer instructions in the storage to maintain a count of ratings made by the user for each of the activities.

In an embodiment, the system further comprises computer instructions in the storage to change a display characteristic of a mark for a displayed activity based upon the count of positive ratings for each of the activities relative to the counts of positive ratings for other of the activities displayed on the map representation. In an embodiment, the display characteristic of the mark for the displayed activity may be larger based upon the greater count of positive ratings relative to the counts of positive ratings for other of the activities displayed on the map representation. In an embodiment, the display characteristic may be smaller based on a lower count of positive ratings relative to the counts of positive ratings for other of the activities displayed on the map representation.

In an embodiment, the system further comprises computer instructions in the storage to display a display characteristic of the mark for the displayed activity having the count of positive ratings above a threshold level when a display scale of the map representation is increased to cover a larger geographical area. In an embodiment, threshold level may increase as the display scale of the map representation is increased or the threshold level may decrease as the display scale is decreased.

In an embodiment, a system for providing entertainment information comprises: a) a first processor connected to a communication network for receiving information; b) a first storage connected to the processor, wherein the first storage is a non-transitory computer readable medium; c) a user's information handling device, wherein the user's information handling device comprises: i) a second processor connected to the communication network for sending information; ii) a second storage connected to the second processor, wherein the second storage is a non-transitory computer readable medium; d) computer instructions in the first storage to download a copy of a user program to the second storage; e) computer instructions in the first storage and/or in the second storage to perform an account initiation process for a user to create or modify a user record for a database of activities; f) computer instructions in the first storage and/or in the second storage to request and receive age information from the user; g) computer instructions in the first storage and/or in the second storage to determine if the user's age is equal to or greater than legal drinking age; h) computer instructions in the first storage and/or in the second storage to request and receive interest information from the user; and i) computer instructions in the first storage and/or in the second storage to create or modify the user record for the user.

In an embodiment, the system further comprises computer instructions in the first storage and/or in the second storage to provide a disclaimer to the user and to request acceptance of the disclaimer from the user.

In an embodiment, the system further comprises computer instructions in the first storage and/or in the second storage to receive acceptance information from the user.

In an embodiment, a system for providing entertainment information comprises: a) information from a user's information handing device, wherein the user's information handling device comprises a display screen; b) a processor connected to a communication network for receiving the information; c) a storage connected to the processor, wherein the storage is a non-transitory computer readable medium; d) computer instructions in the storage to receive an indication of the user's access of a database of activities, wherein each of the activities have an activity location associated with the activity; e) computer instructions in the storage to determine a current location of the user's information handling device; f) computer instructions in the storage to present an initial screen on the display screen of the user's information handling device, including: i) computer instructions to display a map representation on an initial screen of the information handling device; ii) computer instructions to display on the map representation at least one mark representing the activity location of the corresponding activity; and iii) computer instructions to request and receive an activity selection from the user.

In an embodiment, the system further comprises computer instructions in the storage to display further information regarding the activity selected by the user.

In an embodiment, the system further comprises computer instructions in the storage to provide a rating input for the selected activity, wherein the rating input being displayed on the screen with the further information.

In an embodiment, the system further comprises computer instructions in the storage to maintain a count of ratings made by the user for each of the activities.

In an embodiment, the system further comprises computer instructions in the storage to change a display characteristic of the mark for the displayed activity based upon the count of positive ratings for each of the activities relative to the counts of positive ratings for other of the activities displayed on the map representation. In an embodiment, the display characteristic of the mark for the displayed activity may be larger based upon the greater count of positive ratings relative to the counts of positive ratings for other of the activities displayed on the map representation. In an embodiment, the display characteristic may be smaller based on a lower count of positive ratings relative to the counts of positive ratings for other of the activities displayed on the map representation.

In an embodiment, the system further comprises computer instructions in the storage to display a display characteristic of the mark for the displayed activity having the count of positive ratings above a threshold level when a display scale of the map representation is increased to cover a larger geographical area.

In an embodiment, the threshold level may increase as the display scale of the map representation is increased or the threshold level may decrease as the display scale is decreased.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood when consideration is given to the drawings and the detailed description which follows. Such description makes reference to the annexed drawings wherein:

FIG. 1 is a schematic flow diagram of a new method for providing entertainment information according to the present disclosure;

FIG. 2 is a schematic flow diagram of a user initiation aspect of the method for providing entertainment information, according to an illustrative embodiment;

FIG. 3 is a schematic flow diagram of a user session aspect of the method for providing entertainment information, according to an illustrative embodiment;

FIG. 4 is a schematic diagram of a system for providing entertainment information, according to an illustrative embodiment;

FIG. 5 is a schematic front view of an information handling device with a display screen displaying aspects of the system, according to an illustrative implementation;

FIG. 6 is a schematic front view of an initial screen with a map representation of the system, according to an illustrative implementation;

FIG. 7 is a schematic front view of a further information window of the system, according to an illustrative implementation;

FIG. 8 is a schematic front view of a screen associated with an initiation process of the system, according to an illustrative implementation;

FIG. 9 is a schematic front view of a portion of a screen with a button associated with a positive rating response, according to an illustrative implementation; and

FIG. 10 is a schematic front view of representations of marks utilized the locations of activities on the map representation, according to an illustrative implementation.

### DETAILED DESCRIPTION OF EMBODIMENTS OF THE INVENTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

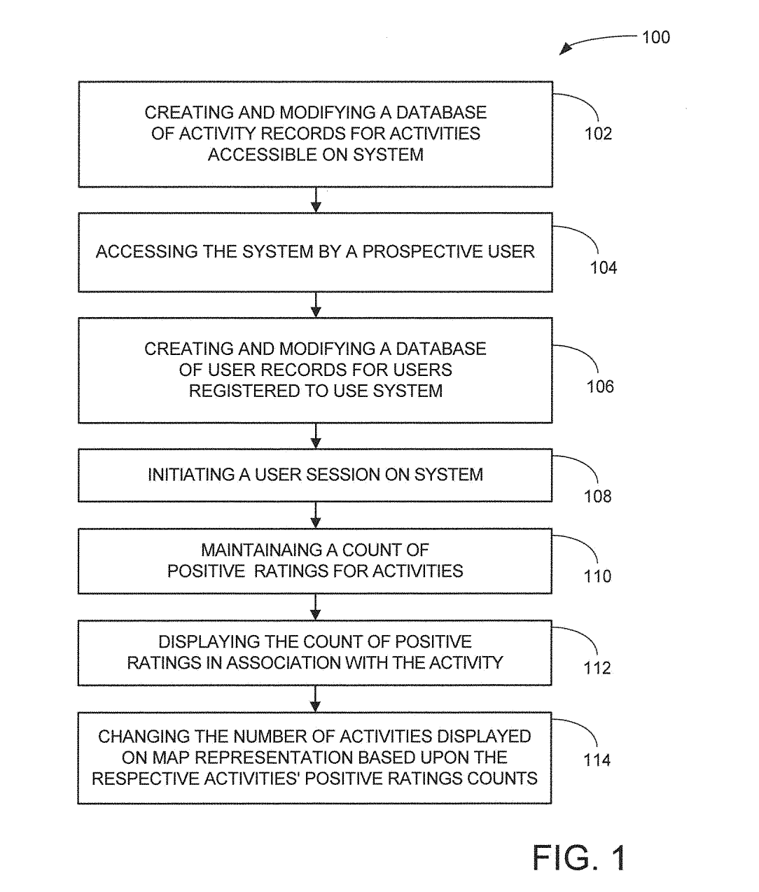

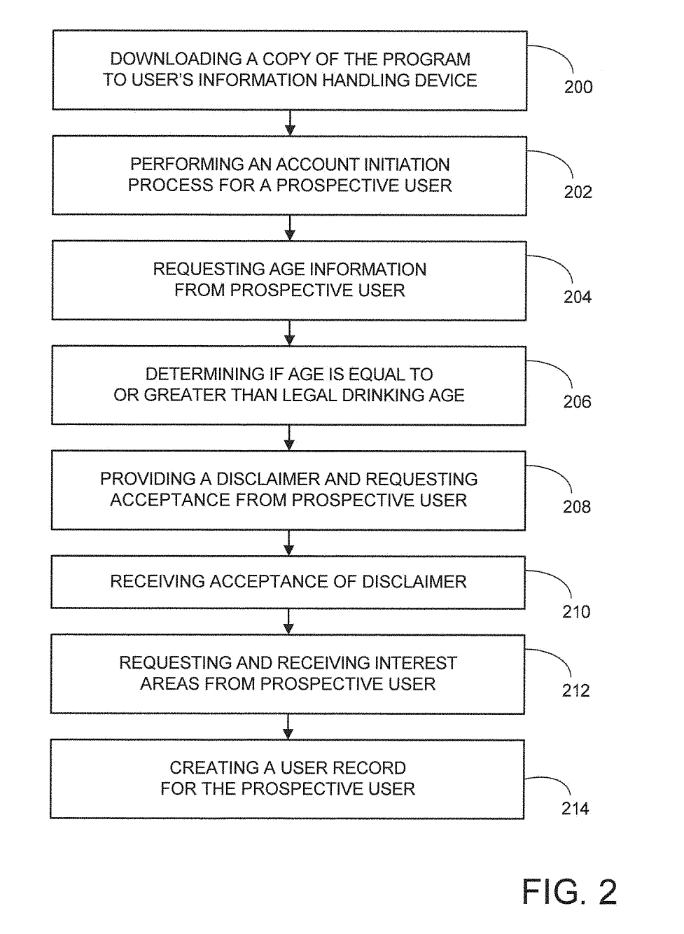

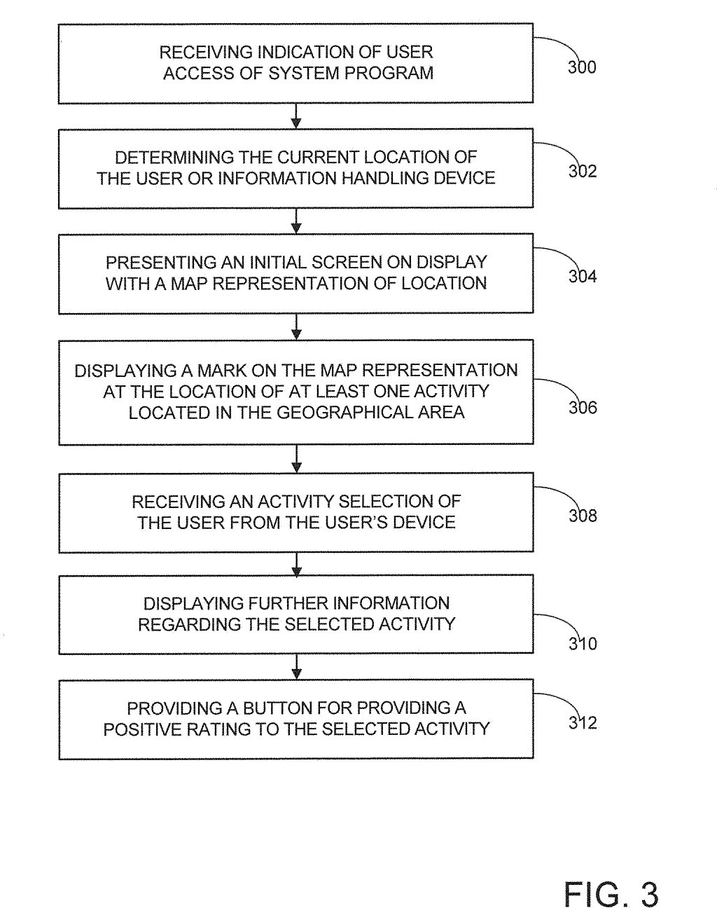

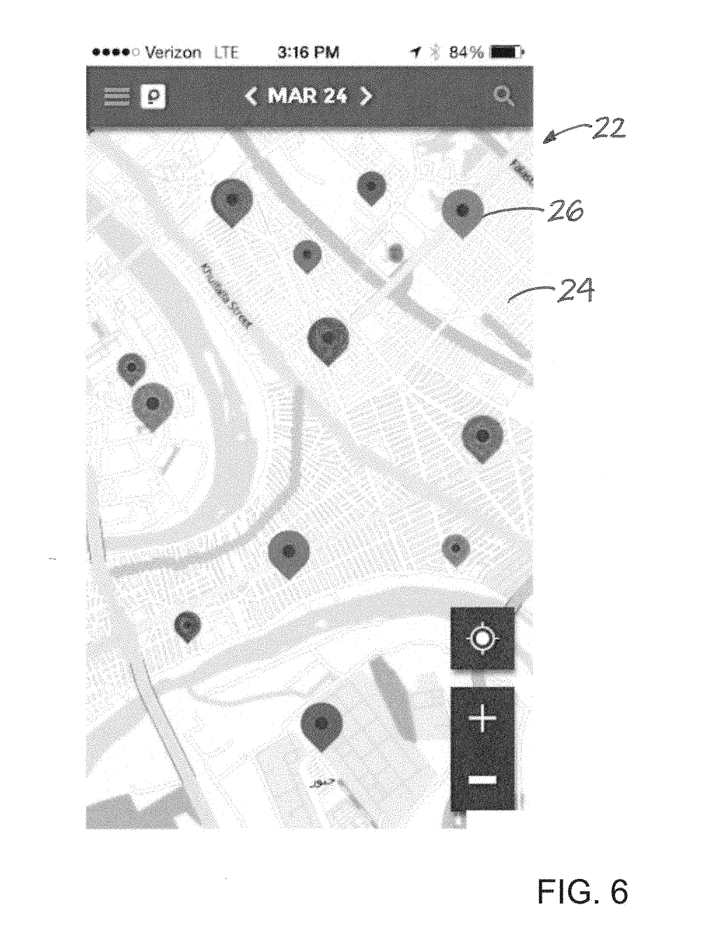

With reference now to the drawings, and in particular to FIGS. 1 through 10 thereof, a new system and method for providing entertainment information embodying the principles and concepts of the disclosed subject matter will be described.

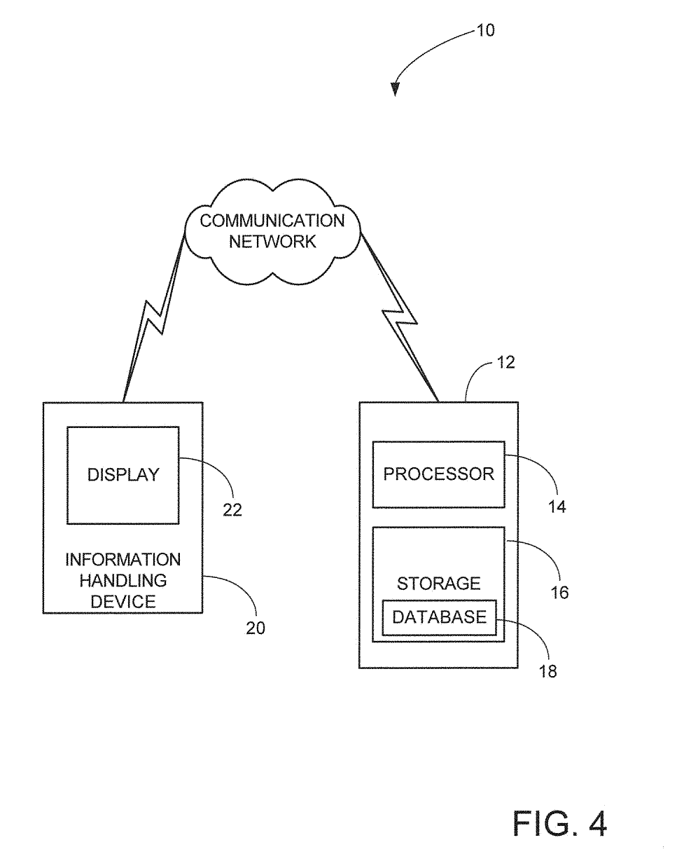

In some aspects, the disclosure relates to a system 10 for providing entertainment information to users of the system in a convenient format, such as through devices that are typically carried on the person of potential users of the system. (See e.g., FIGS. 4-7). The system may include a server 12, with a processor 14 and storage 16 or memory capable of administering or maintaining a database 18 of information and a system program of computer instructions. The system 10 may also include at least one, and optionally a plurality of, information handling devices 20 utilized by users or potential users of the system. The information handling devices 20 may have a display screen 22 for displaying graphical and alphanumeric information and which may or may not be touch sensitive. The information handling device may include a processor (not shown) and a storage (not shown) or memory capable of administering or maintaining a database (not shown) of user information and/or a user program. Suitable information handling devices may have a data communication capability over, for example, cellular communication networks and Wi-Fi networks as well as any other type or mode of wireless data communication. Examples of some suitable information handling devices include cell phones, smartphones, tablets, personal computers, and various combinations and variations thereof.

In other aspects, the disclosure relates to a method 100 of providing entertainment information in an interactive manner through convenient information handling device platforms such as smartphones and tablets.

The method 100 may include creating or supplementing a database of information, which may include information on activities about which the information may be provided to users of the system (block 102), as well as information on the users registered to use the system. The database may thus include, for example, activity records and user records that may be created and then updated or changed as necessary (block 106). In some implementations, the database may include activity records with each record holding information regarding a particular activity which has been registered with the system and for which information may be provided to the user of the system in the manner set forth in this disclosure. The activity record for each activity may have various types of information recorded in the record. For example, each activity may have an activity location recorded for the activity, and is generally the geographical or physical location which is associated with the activity, such as the address of the building in which the activity is located or held, and the location typically does not change although some activities may have locations that vary from time to time.

In general, the activities may also be generally classified as ongoing activities and one time activities. Ongoing activities may be thought of those that occur regularly and in many cases occur every day, or several times a week. Examples of ongoing activities may include bars, restaurants, theaters, sporting event, and the like. One time activities are held once or sporadically such as once a week, once a month, once a year or only once. Examples of one time activities may include concerts, celebrations, conventions, trade shows, and the like. Typically, although not necessarily, each activity will have a start time and may also have an end time which may define the duration of the activity. For example, a bar or restaurant may have a “happy hour” that occurs each day (or most days) of the week and may have a start time and an end time occurring each day that the happy hour specials are offered. Further, each activity may be assigned to one of two or more interest categories to generally categorize the activity to facilitate matching activities to the interests of users of the system as well as providing enhanced search capabilities for particular types of activities in the database of the system. Additional types of information regarding the activities may be recorded in the activity record as well.

The method may also include accessing the system by a user or prospective user (block 104). If a prospective user, accessing the system for the first time (or one of the first times) may include downloading a copy of a program of instructions to the information handling device 20 of a prospective user (block 200). The program of instructions may comprise a software application, or app, and may be made available in any suitable manner to prospective customers for download to the users information handling device. Optionally, the functions of the system may be carried out in other ways, such as on a webpage accessible through the web browser program operating on a device 20 such as a smartphone, tablet or personal computer.

Upon accessing one of the portals to the system, such as the app or website, a new user account initiation process may be performed (block 202) to create a user record in the user database which may be maintained on the system, such as on the storage devices of the server. The initiation process may include requesting age information from a prospective user, and receiving age information from the prospective user (block 204). The initiation process may also include recording the age of the user in the user record, as well as determining if the age of the prospective user is equal to or greater than a predetermined age (block 206). The predetermined age may be, for example, the legal drinking age for a particular jurisdiction in which the system is being utilized, such as a state.

The initiation process may also include providing a disclaimer to the prospective user (block 208), and may include displaying the language of the disclaimer on the display screen of the information handling device of the user. The process may also include requesting an acceptance of the terms of the disclaimer by the prospective user, as well as receiving the acceptance of the terms of the disclaimer by the prospective user (block 210). If acceptance of the terms of the disclaimer is not received by the system, the initiation process may be terminated and the prospective user advised of the reason for termination of the process.

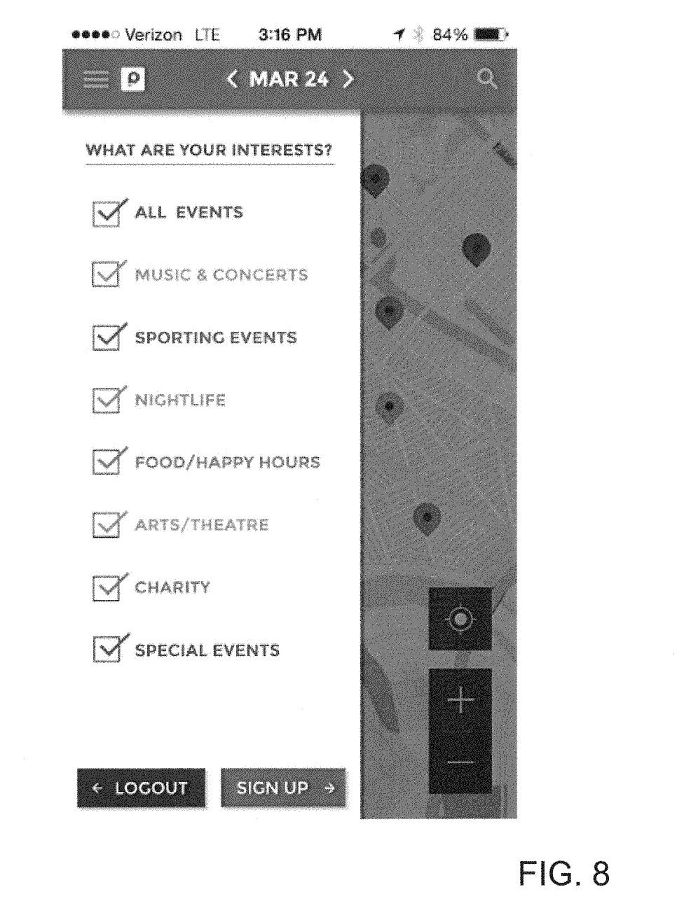

Other aspects of the initiation process may include requesting an indication from the prospective user of at least one interest area of the prospective user (see e.g., FIG. 8), and may include receiving the indication of the at least one interest area from the prospective user (block 212). The one or more interest areas indicated by the prospective user may be stored in the user record in the database. The initiation process may also include creating a user record that includes biographical information regarding the prospective user as well as various information specific to the system (block 214), such as the age of the user, the acceptance of the terms of use set forth and in the disclaimer, as well as one or more interest areas of the user.

The method may also include initiating a user session in which the user accesses resources on the system (block 108). The initiation of a user session may include receiving an indication of access of the system, such as opening or interacting with client software, an app or a webpage for the system in a browser, by the user on his or her information handling device (block 300). The initiation of the user session may also include determining a current location of the user, or the user's information handling device, and may include receiving current location information from the information handling device of the user at the time that the session is initiated (block 302). For example, the location information may result from user input on the device 20 of by reading current location information available from other resources on the device, such as a Global Positioning Satellite (GPS) service on the device. Additional location information may be received during the user session for updating the user location should it vary during the user session such as through movement of the device 20. In some implementations, the user session may utilize an alternative location which is not the current location of the user, but is, for example, a location indicated by the user as being a location of interest for which the user may be seeking information regarding activities occurring in that alternative location. Thus, alternate location information may be received by the system from the information handling device which may be treated the same as the current location information for the purposes of other steps or actions taken by the system.

The initiation of a user session may also include presenting an initial screen on the user's information handling device (block 304). The presentation of an initial screen may include displaying a map representation on the initial screen of the information handling device. The map representation may be of a geographical area that includes the current location of the user (or the alternate location indicated by the user). In some implementations, the size of the geographical area displayed may vary, and may vary based upon the relative number of activities in the activities database of the system that are located in the geographical area being displayed. For example, if the geographical area includes the location of many activities, such that display of the map representation may become unsuitably cluttered, the size of the geographical area depicted on the map representation may be decreased to a degree that reduces the number of activities within the geographical area, and thus displayed on the map representation, to a suitable number. Conversely, in areas that have relatively few activities to display, the scale of the map representation may be enlarged to show a larger geographical area and possibly more activities. The display for the user interface for the user session may also include displaying a current time on the initial screen.

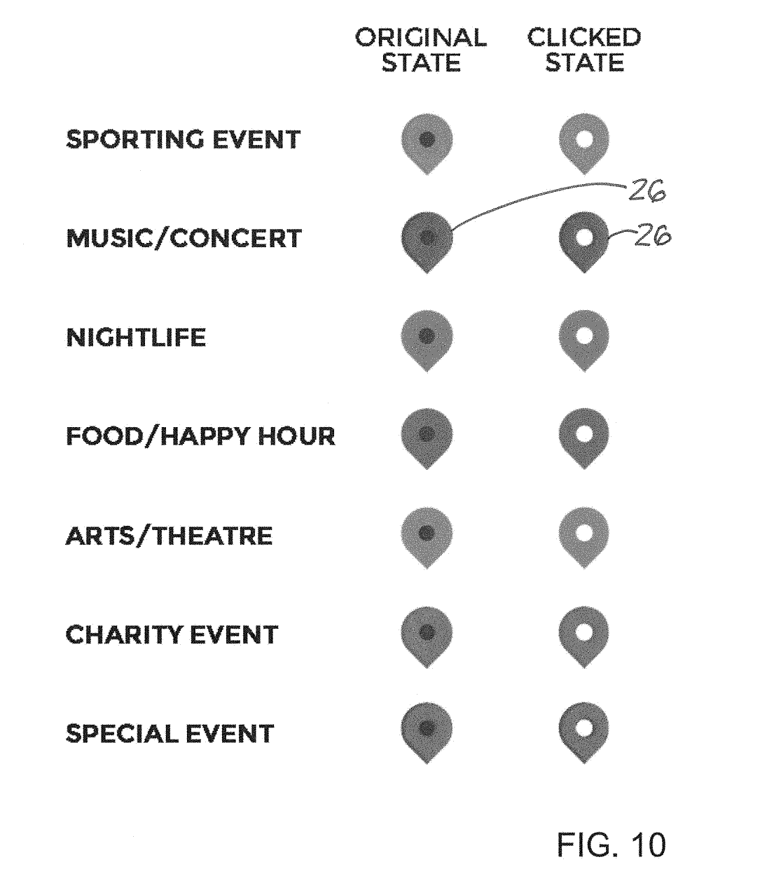

Initiation of the user session may also include displaying on the map a representation of at least one mark representing the activity location of the corresponding activity, or the activity corresponding to the location of the mark on the map representation (block 306). In some implementations, all activities in the database that occur in the geographical area shown on the map representation are displayed simultaneously, or substantially simultaneously. The mark may have a display color which may be associated with the particular interest category into which the activity has been classified, with the marks for activities having similar or the same interest category being displayed with the same or similar color. (See e.g., FIG. 10). In some implementations, the display color of the mark may change when the mark is selected by the user to confirm that the mark, and the activity represented by the mark, has been selected. The mark may also have a display size and a display shape, each of which may be varied depending upon various factors.

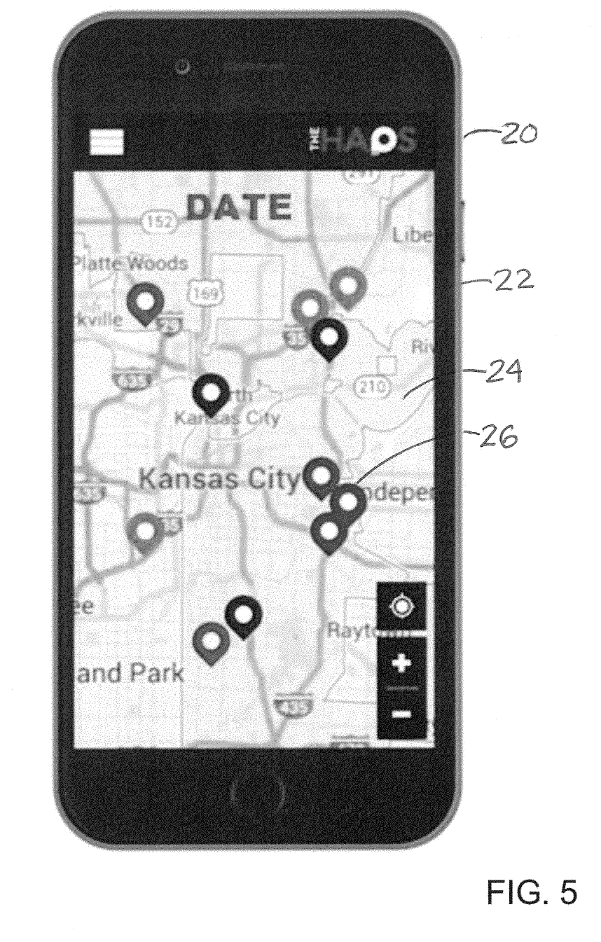

The method may also include receiving an activity selection from the user's information handling device (block 308). The selection of the activity by the user may be made by contact with an area of the display screen where the mark is displayed associated with the mark, which is suitable for touch screen display screens, or may be initiated by clicking a cursor on the mark on the location of the mark on the screen. In some implementations, selecting an activity may change an aspect of the appearance of the mark 26 of the selected activity depicted on the display screen of the user's device. (See e.g., FIGS. 5-7).

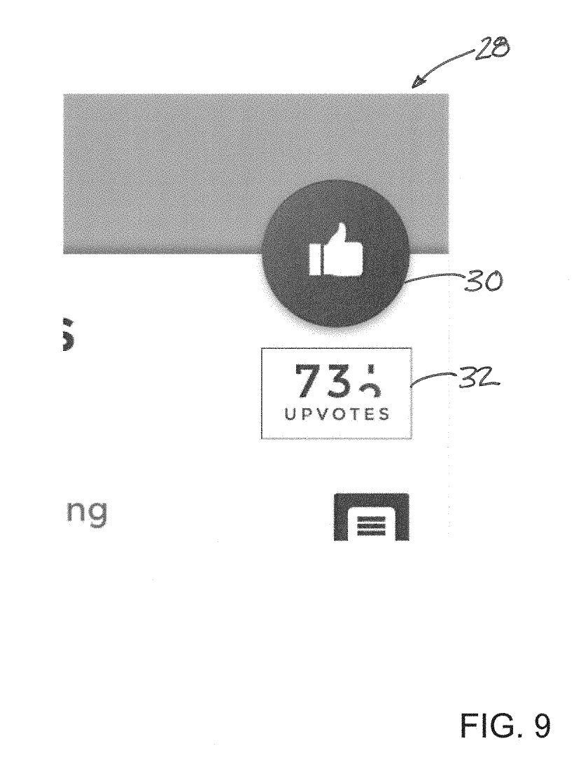

The method may also include the step of displaying further information regarding the activity selected by the user (block 310), which may be displayed in a window 28 on the display screen of the user's information handling device. The window may be a pop-up window, and may be located over a portion of the map representation 24 on the display 22 or may occupy substantially the entire area of the display screen on the device and may hide the map representation. (See e.g., FIGS. 5-7). Further information regarding the activity may include a name for the activity as well as a description of the activity. The information displayed in the window 28 may also include special offers that may be obtained or utilized in connection with the selected activity. (See e.g., FIG. 9). Additionally, the window information may include a link to a webpage that includes information connected with the activity. Further, the information displayed in the window may include directions or a directions link. Other window information may also include a ticket purchase link which links to a webpage or website through which tickets for the activity may be purchased. Further links in the window may include links to popular social media sites or services.

The method may also include providing the user with the opportunity to provide a positive rating input for the selected activity (block 312). The positive rating input, such as a button, may be located on the window along with the information along with information regarding the activity, but may be located on other windows as well.

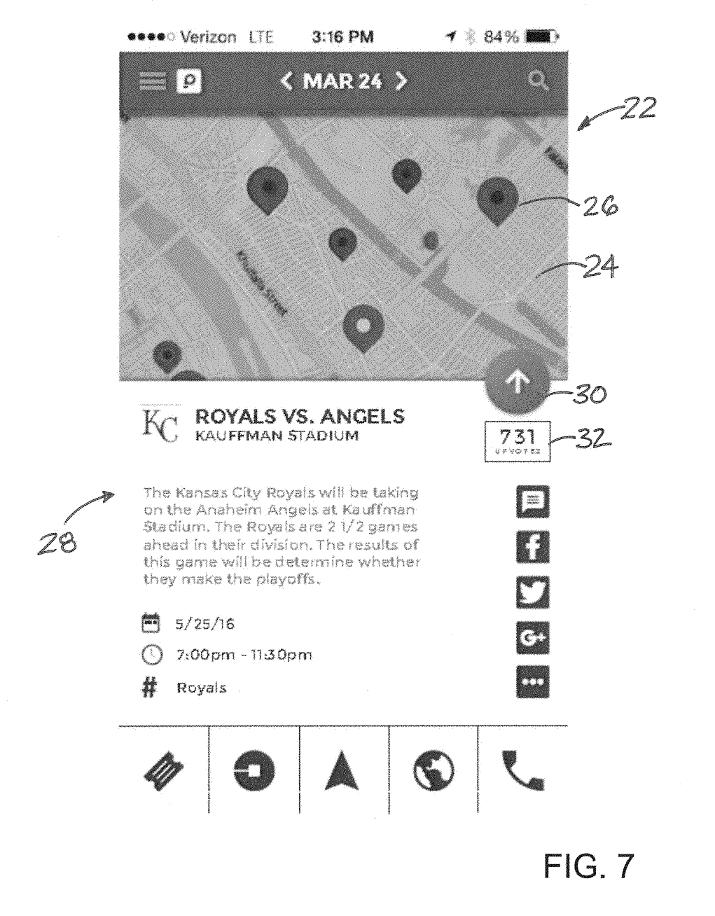

The method may also include maintaining a count of the positive ratings made by users of the system for each of the activities (block 110), and may include storing a count in the database of the positive ratings given by users. The count of positive ratings may be incremented higher each time a user provides a positive rating input for the respective activity by selecting the rating input 30. (See e.g., FIG. 7). In some implementations, the count of positive ratings may be counted over a time period, and in other implementations the count may be historical over the entire period that the activity has been listed on the system.

The method may also include the step of displaying the count of positive ratings in association with the activity, such as in the window with the further information that is displayed in the window (block 112), and may represent the count taken over the time period. This may include displaying an indicator 32 of the count of positive ratings, such as a numeral representing the count, but may also include changing an aspect of the indicator of the count of positive ratings or the mark 26 as the count exceeds at least one count level or threshold. (See e.g., FIGS. 5-7). Further, in some implementations of the method, the duration of the time period over which the count of positive reviews has been measured may be changed as the count of positive reviews increases. An indication of the duration of the time period being utilized may be displayed in the window, such as year, month, week day or some other period. In some implementations, the display size of the mark may be associated with the count of positive ratings. For example, the greater the relative number of positive ratings that an activity has received relative to other activities, the larger the display size of the mark 26 relative to other marks for activities with lesser counts. Conversely, the fewer the relative number of positive ratings that an activity has received relative to other activities, the smaller the display size of the mark relative to other marks for activities with lesser counts.

The method may also include providing a capability to the user to change the display scale of the map representation, may include the capability to increase our or decrease the display scale of the map representation such that the geographic area displayed on the map representation is increased or decreased to encompass more or less area.

With respect to the map representation, when the display scale is increased such that the map representation covers a larger geographical area, the method may include displaying the marks associated with activities having the count of positive ratings above a threshold level (block 114). The threshold level applied to the counts of the activities may increase in number as the size of the geographical area displayed is increased. In some implementations, this step may include eliminating from the display the marks associated with activities having counts of positive ratings that are lower than the threshold. In some implementations, enlarging the area encompassed by the map representation may correspondingly increase the number of activities that may be displayed on the map representation, which could potentially cause the map representation to become so filled with marks associated with activities that it becomes difficult to distinguish the marks of different activities from each other. Therefore, as the area of the map representation is increased, the threshold number for the count of positive ratings needed to be displayed on the map representation may be correspondingly increased to thereby eliminate the marks for some of the activities displayed on the map representation so that the number of activities displayed is less than the actual number of activities located in the geographical area, and a smaller number of marks representing fewer than the actual number of activities located in the geographical area are displayed.

It should also be appreciated from the foregoing description that, except when mutually exclusive, the features of the various embodiments described herein may be combined with features of other embodiments as desired while remaining within the intended scope of the disclosure.

Further, those skilled in the art will appreciate that the steps shown in the drawing figures may be altered in a variety of ways. For example, the order of the steps may be rearranged, substeps may be performed in parallel, shown steps may be omitted, or other steps may be included, etc.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

Definitions

As used herein, the terms “a,” “an,” “the,” and “said” mean one or more, unless the context dictates otherwise.

As used herein, the term “about” means the stated value plus or minus a margin of error or plus or minus 10% if no method of measurement is indicated.

As used herein, the term “or” means “and/or” unless explicitly indicated to refer to alternatives only or if the alternatives are mutually exclusive. As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise,” provided above.

As used herein, the terms “having,” “has,” and “have” have the same open-ended meaning as “comprising,” “comprises,” and “comprise,” provided above.

As used herein, the terms “including,” “includes,” and “include” have the same open-ended meaning as “comprising,” “comprises,” and “comprise,” provided above.

As used herein, the phrase “consisting of” is a closed transition term used to transition from a subject recited before the term to one or more material elements recited after the term, where the material element or elements listed after the transition term are the only material elements that make up the subject.

As used herein, the term “simultaneously” means occurring at the same time or about the same time, including concurrently.

Incorporation By Reference. All patents and patent applications, articles, reports, and other documents cited herein are fully incorporated by reference to the extent they are not inconsistent with this invention.

We claim:

1. A system for providing entertainment information, wherein the system comprises:
a. information from a user's information handing device, wherein the user's information handling device comprises a display screen;
b. a processor connected to a communication network for receiving the information;
c. a storage connected to the processor, wherein the storage is a non-transitory computer readable medium;
d. computer instructions in the storage to create a database of activities, wherein each of the activities have an activity location associated with the activity,
e. computer instructions in the storage to perform an initiation process for a user to create or modify a user record in the database;
f. computer instructions in the storage to initiate a user session, including:
i. computer instructions to determine a location for the user;
ii. computer instructions to present an initial screen on the display screen of the user's information handling device, including:
A. computer instructions to display a map representation on the initial screen of the user's information handling device;
B. computer instructions to display on the map representation at least one mark representing the activity location of the corresponding activity; and
C. computer instructions to request and to receive an activity selection from the user.

2. The system of claim 1, further comprising computer instructions in the storage to display further information regarding the activity selected by the user.

3. The system of claim 2, further comprising computer instructions in the storage to provide a rating input for the selected activity, wherein the rating input being displayed on the screen with the further information.

4. The system of claim 3, further comprising computer instructions in the storage to maintain a count of ratings made by the user for each of the activities.

5. The system of claim 4, further comprising computer instructions in the storage to change a display characteristic of the mark for the displayed activity based upon the count of positive ratings for each of the activities relative to the counts of positive ratings for other of the activities displayed on the map representation.

6. The system of claim 4, further comprising computer instructions in the storage to display a display characteristic of the mark for the displayed activity having the count of positive ratings above a threshold level when a display scale of the map representation is increased to cover a larger geographical area.

7. The system of claim 6, wherein the threshold level may increase as the display scale of the map representation is increased or the threshold level may decrease as the display scale is decreased.

8. A system for providing entertainment information, wherein the system comprises:
a. a first processor connected to a communication network for receiving information;
b. a first storage connected to the processor, wherein the first storage is a non-transitory computer readable medium;
c. a user's information handling device, wherein the user's information handling device comprises:
i. a second processor connected to the communication network for sending information;
ii. a second storage connected to the second processor, wherein the second storage is a non-transitory computer readable medium;
d. computer instructions in the first storage to download a copy of a user program to the second storage;
e. computer instructions in the first storage and/or in the second storage to perform an account initiation process for a user to create or modify a user record for a database of activities;
f. computer instructions in the first storage and/or in the second storage to request and receive age information from the user;
g. computer instructions in the first storage and/or in the second storage to determine if the user's age is equal to or greater than legal drinking age; and
h. computer instructions in the first storage and/or in the second storage to request and receive interest information from the user; and
i. computer instructions in the first storage and/or in the second storage to create or modify the user record for the user.

9. The system of claim 8, further comprising computer instructions in the first storage and/or in the second storage to provide a disclaimer to the user and to request acceptance of the disclaimer from the user.

10. The system of claim 9, further comprising computer instructions in the first storage and/or in the second storage to receive acceptance information from the user.

11. A system for providing entertainment information, wherein the system comprises:
a. information from a user's information handing device, wherein the user's information handling device comprises a display screen;
b. a processor connected to a communication network for receiving the information;
c. a storage connected to the processor, wherein the storage is a non-transitory computer readable medium;
d. computer instructions in the storage to receive an indication of the user's access of a database of activities, wherein each of the activities have an activity location associated with the activity;
e. computer instructions in the storage to determine a current location of the user's information handling device;
f. computer instructions in the storage to present an initial screen on the display screen of the user's information handling device, including:
i. computer instructions to display a map representation on an initial screen of the information handling device;
ii. computer instructions to display on the map representation at least one mark representing the activity location of the corresponding activity; and
iii. computer instructions to request and receive an activity selection from the user.

12. The system of claim 11, further comprising computer instructions in the storage to display further information regarding the activity selected by the user.

13. The system of claim 12, further comprising computer instructions in the storage to provide a rating input for the selected activity, wherein the rating input being displayed on the screen with the further information.

14. The system of claim 13, further comprising computer instructions in the storage to maintain a count of ratings made by the user for each of the activities.

15. The system of claim 14, further comprising computer instructions in the storage to change a display characteristic of the mark for the displayed activity based upon the count of positive ratings for each of the activities relative to the counts of positive ratings for other of the activities displayed on the map representation.

16. The system of claim 14, further comprising computer instructions in the storage to display a display characteristic of the mark for the displayed activity having the count of positive ratings above a threshold level when a display scale of the map representation is increased to cover a larger geographical area.

17. The system of claim 16, wherein the threshold level may increase as the display scale of the map representation is increased or the threshold level may decrease as the display scale is decreased.
